(19) United States
(12) Patent Application Publication
(10) Pub. No.: US 2016/0349779 A1
(43) Pub. Date: Dec. 1, 2016

(54) METHOD AND DEVICE FOR CONTROLLING SMART HOME POWER SUPPLY

(71) Applicant: Xiaomi Inc., Beijing (CN)

(72) Inventors: Jie FAN, Beijing (CN); Shanrong Liu, Beijing (CN); Wei Sun, Beijing (CN)

(73) Assignee: Xiaomi Inc., Beijing (CN)

(21) Appl. No.: 15/051,237

(22) Filed: Feb. 23, 2016

(30) Foreign Application Priority Data
May 27, 2015 (CN) 201510280550.8

(51) Int. Cl. G05F 1/66; H04L 12/28; G05B 15/02

(52) U.S. Cl. CPC G05F 1/66; G05B 15/02; H04L 12/2816

(57) ABSTRACT

A method and a device are provided for controlling a smart home power supply. In the method, the device obtains one or more addresses for one or more smart home power supplies connected to the smart router, and obtains information on a plurality of home appliances connected to the one or more smart home power supplies. The device establishes a correspondence between the information on the home appliances and the addresses of the one or more smart home power supplies; and obtaining control information for a home appliance. The device searches for an address of a smart home power supply connected to the home appliance from the correspondence. The device sends a control instruction to the smart router according to the control information and the address of the smart home power supply to control the smart home power supply to perform a corresponding operation.

### CROSS-REFERENCE TO RELATED APPLICATION

The present application is based upon and claims priority to Chinese Patent Application No. 201510280550.8, filed May 27, 2015, the entire contents of which are incorporated herein by reference.

### TECHNICAL FIELD

The present disclosure generally relates to the field of smart home, and more particularly, to a method and a device for controlling a smart home power supply.

### BACKGROUND

With development of science and technologies, the conception of smart home has deeply gone into our social life. The smart home utilizes advanced technologies such as computer sciences, networks and communications, automatic control, and the like to incorporate various application subsystems relating to home life, and makes our home life more comfortable, more safe, more efficient and more energy-saving by integrated managements. As compared with an ordinary home, the smart home not only has conventional residential function but also provides a live space which is comfortable, safe, efficient, energy-saving and of more humanity and thereby is capable of optimizing people's life styles.

At present, corresponding products for a smart home have come out, such as smart TVs, smart refrigerators, smart air conditioners, and the like. The smart products in a smart home may greatly meet users' requirements and facilitate operations to make life become more varied and wonderful.

### SUMMARY

Embodiments of the present disclosure provide a method and a device for controlling a smart home power supply to realize a smart control on a plurality of smart home power supplies to greatly facilitate user's operations and usage.

According to a first aspect of embodiments of the present disclosure, there is provided a method for controlling a smart home power supply. In the method, the device obtains an assigned address for a smart home power supply connected to a smart router, and obtains information on one or more home appliances connected to the smart home power supply. The device saves a correspondence between the information on the one or more home appliances and the assigned address of the smart home power supply in a correspondence storage; and obtaining control information for a target home appliance. The device searches for an address of a smart home power supply connected to the target home appliance from the correspondence storage. The device sends a control instruction to the smart router according to the control information and the address of the smart home power supply to control the smart home power supply to perform a corresponding operation.

According to a second aspect of embodiments of the present disclosure, there is provided a device for controlling a smart home power supply. The device includes: a processor; and a memory for storing instructions executable by the processor. The processor is configured to perform: obtaining one or more assigned addresses for one or more smart home power supplies connected to the smart router, and obtaining information on a plurality of home appliances connected to the smart home power supplies; saves a correspondence between the information on the home appliances and the one or more assigned addresses of the one or more smart home power supplies in a correspondence storage; and obtaining control information set for a home appliance by a user, searching an address of a smart home power supply connected to the home appliance from the correspondence, and sending a control instruction to the smart router according to the control information and the address of the smart home power supply to control the smart home power supply to perform a corresponding operation.

According to a third aspect of embodiments of the present disclosure, there is provided a non-transitory readable storage medium including instructions, executable by a processor in a device for performing acts. The acts include: obtaining assigned addresses for the one or more smart home power supplies connected to the smart router, and obtaining information on a plurality of home appliances connected to the smart home power supplies; saving a correspondence between the information on the home appliances and the assigned addresses of the smart home power supplies in a correspondence storage; and obtaining control information set for a home appliance by a user, searching an address of a smart home power supply connected to the home appliance from the correspondence, and sending a control instruction to the smart router according to the control information and the address of the smart home power supply to control the smart home power supply to perform a corresponding operation.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the present invention.

FIG. 1 is a flowchart showing a method for controlling a smart home power supply according to an exemplary embodiment.

FIG. 2 is a diagram schematically showing a scenario for controlling smart home power supplies according to another exemplary embodiment.

FIG. 3 is a flowchart showing a method for controlling a smart home power supply according to another exemplary embodiment.

FIG. 4 is a flowchart showing a method for controlling a smart home power supply according to another exemplary embodiment.

FIG. 5 is a block diagram showing a device for controlling a smart home power supply according to another exemplary embodiment.

FIG. 6 is a block diagram showing a device for controlling a smart home power supply according to another exemplary embodiment.

FIG. 7 is a block diagram showing a device for controlling a smart home power supply according to another exemplary embodiment.

FIG. 8 is a block diagram showing a device for controlling a smart home power supply according to another exemplary embodiment.

FIG. 9 is a block diagram showing a device for controlling a smart home power supply according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present invention. Instead, they are merely examples of devices and methods consistent with aspects related to the present invention as recited in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

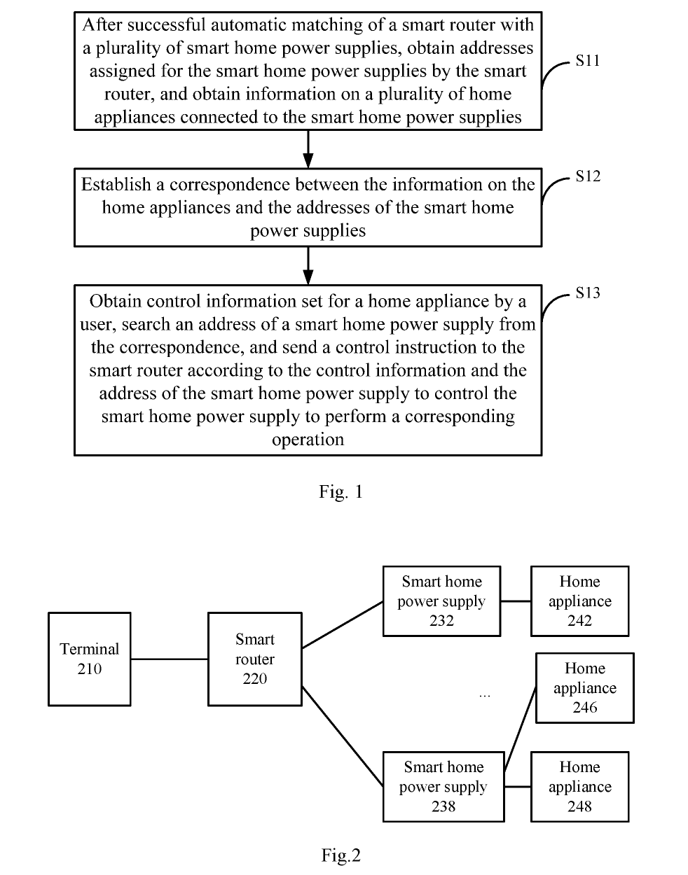

FIG. 1 is a flowchart showing a method for controlling a smart home power supply according to an exemplary embodiment. As shown in FIG. 1, the method may be implemented in a terminal and includes the following steps.

In step S11, after successful automatic matching of a smart router with a plurality of smart home power supplies, addresses assigned for the smart home power supplies by the smart router are obtained, and information on a plurality of home appliances connected to the smart home power supplies is obtained. For example, the terminal connects to the smart router and obtains the assigned addresses for the smart home power supplies from the smart router. The terminal may further obtain the information related to the home appliances connected to each smart home power supply. The information on the plurality of home appliances may include identifications of the plurality of home appliances, power consumption information, usage information, etc.

In step S12, a correspondence between the information on the home appliances and the addresses of the smart home power supplies is saved in a correspondence storage. The terminal may establish a correspondence table that groups the home appliances according to the assigned addresses of the connected smart home power supplies. The terminal may save the correspondence table in a local memory or a remote storage.

In step S13, the terminal obtains control information set for a home appliance. The home appliance in step S13 may be a target home appliance the user intends to control. The control information may be set by the user using the terminal or other devices. The terminal may search for an address of a smart home power supply connected to the home appliance from the correspondence established in step S12. The terminal sends a control instruction to the smart router according to the control information and the address of the smart home power supply to control the smart home power supply to perform a corresponding operation. The control information may be set by a user using the terminal and prestored in a local or remote storage accessible to the terminal.

Referring to FIG. 2, the above method may be implemented in the system shown in the application scenario as shown in FIG. 2. The system includes a terminal 210, a smart router 220, and a plurality of smart home power supplies 232, 238. Each smart home power supply may be connected to one or more smart home appliances. For example, the smart home power supply 238 is connected to smart home appliances 246 and 248. The smart router 220 may automatically match the smart home power supplies 232 or 238 to establish a connection, and the terminal 210 may be connected with the smart router 220 via subnetworks such as WiFi. The states of respective smart home power supplies 232 or 238 may be uploaded to the smart router 220 which may send the received state information to the terminal 210 for display. The terminal 210 may obtain information on the smart home power supplies 232 and 238 and the home appliances via the smart router 220, and control the smart home power supplies 232 or 238 to perform operations by sending a control instruction to the smart router 220, and thereby control use states of corresponding home appliances. Consequently, a user's purpose for remotely controlling the home appliances by a terminal may be achieved.

In one or more embodiments, alternatively or additionally, the connection between the smart router 220 and the smart home power supplies 232 or 238 is a wireless connection including but not limited to Bluetooth, infrared, WiFi, and the like. After successful automatic matching between the smart router 220 and the smart home power supplies 232 or 238, the smart router 220 automatically assigns an address to each of the smart home power supplies 232 or 238. The address is unique and thus may uniquely identify one smart home power supply, and consequently it is guaranteed that the address may distinguish the connected smart power supplies in a home.

In one or more embodiments, alternatively or additionally, the sending of a control instruction to the smart router 220 according to the control information and the address of the smart home power supply to control the smart home power supply to perform a corresponding operation, includes:

when the control information is turning on the smart home power supply, sending a control instruction carrying the address of the smart home power supply to the smart router 220 to control the smart home power supply to perform a turning-on operation; or

when the control information is turning off the smart home power supply, sending a control instruction carrying the address of the smart home power supply to the smart router 220 to control the smart home power supply to perform a turning-off operation.

In one or more embodiments, alternatively or additionally, on and off of a smart home power supply may be controlled by sending a high level or a low level. For example, when a high level is output, a smart home power supply is turned on so that it is guaranteed that a home appliance is powered up. When a low level is output, the smart home power supply is turned off so that it is guaranteed that the home appliance is powered down.

In one or more embodiments, alternatively or additionally, when the control information is turning on the smart home power supply, the sending of a control instruction carrying the address of the smart home power supply to the smart router 220 to control the smart home power supply to perform a turning-on operation, includes:

when the control information is turning on the smart home power supply and includes a starting time, sending a control instruction carrying the address of the smart home power supply and the starting time to the smart router 220 to control the smart home power supply to perform a turning-on operation at the starting time.

In one or more embodiments, alternatively or additionally, when the control information is turning on the smart home power supply and includes a starting time, the sending of a control instruction carrying the address of the smart home power supply and the starting time to the smart router 220 to control the smart home power supply to perform a turning-on operation at the starting time, includes:

when the control information is turning on the smart home power supply and includes the starting time and a lasting time, sending a control instruction carrying the address of the smart home power supply, the starting time and the lasting time to the smart router 220 to control the smart home power supply to perform a turning-on operation at the starting time and to perform a turning-off operation when a turning-on duration reaches the lasting time.

In one or more embodiments, alternatively or additionally, the above method may further include:

obtaining information on usage habits set for the home appliances by the user;

when the information on usage habits indicates that a home appliance is not frequently used, detecting on a regular interval whether a turning-on duration of a smart home power supply connected to the home appliance exceeds a preset threshold; and

if the turning-on duration exceeds the threshold, sending a control instruction to the smart router 220 to control the smart home power supply to perform a turning-off operation.

In one or more embodiments, alternatively or additionally, the obtaining of control information set for a home appliance by a user includes:

providing the information on the home appliances to the user, and receiving control information set for a home appliance by the user; or

analyzing the information on the home appliances to generate the control information.

In one or more embodiments, alternatively or additionally, the information on the home appliances includes identification information of the home appliances, or includes both the identification information and property information of the home appliances, wherein the property information is displayed when being viewed by the user.

In the above method provided by one or more embodiments, after successful automatic matching of a smart router 220 with a plurality of smart home power supplies, addresses assigned for the smart home power supplies by the smart router 220 are obtained, and information on a plurality of home appliances connected to the smart home power supplies are obtained; a correspondence between the information on the home appliances and the addresses of the smart home power supplies is established; control information set for a home appliance by a user is obtained, an address of a smart home power supply connected to the home appliance is searched from the correspondence, and a control instruction is sent to the smart router 220 according to the control information and the address of the smart home power supply to control the smart home power supply to perform a corresponding operation. Thus, a smart control on the smart home power supplies is realized to greatly facilitate user's operations and usage. Consequently, purposes such as energy-saving, safety and convenience to life are achieved and optimized usage and management of home appliances are realized.

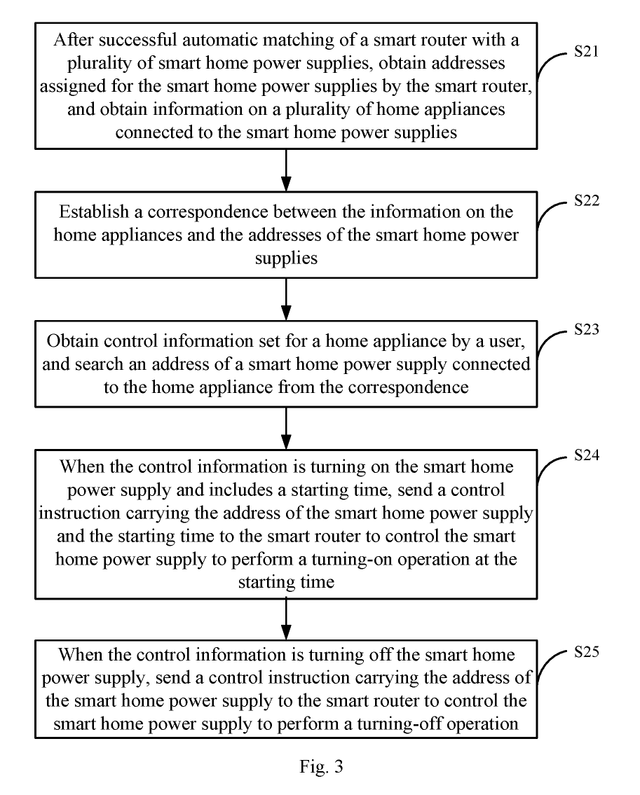

FIG. 3 is a flowchart showing a method for controlling a smart home power supply according to another exemplary embodiment. As shown in FIG. 3, the method may be implemented in a terminal and includes the following steps.

In step S21, after successful automatic matching of a smart router with a plurality of smart home power supplies, addresses assigned for the smart home power supplies by the smart router are obtained, and information on a plurality of home appliances connected to the smart home power supplies is obtained.

In one or more embodiments, alternatively or additionally, the information on the home appliances includes identification information of the home appliances, or includes both the identification information and property information of the home appliances. The property information is displayed when being viewed by a user. The property information includes but is not limited to rated power of the home appliances, power consumption when the home appliances are in a standby state, the time when the home appliances are firstly used, life spans, expiration dates or the time for performing quality check, and the like. The property information is convenient for user's view and may facilitate the user to know the degree of aging and power consumption of the home appliances.

In step S22, a correspondence between the information on the home appliances and the addresses of the smart home power supplies is established. The correspondence may be updated when the user unplugs a home appliance from one smart home power supply and plugs the home appliance to another smart home supply. The terminal may save the correspondence in a correspondence storage in the terminal or in the cloud.

In step S23, control information set for a home appliance by a user is obtained, an address of a smart home power supply connected to the home appliance is searched from the correspondence. Here, the home appliance may be a target home appliance the user intends to control.

The obtaining of control information set for a home appliance by a user includes: providing the information on the home appliances to the user, and receiving control information set for a home appliance by the user; or analyzing the information on the home appliances to generate the control information.

In step S24, when the control information is turning on the smart home power supply and includes a starting time, a control instruction carrying the address of the smart home power supply and the starting time is sent to the smart router to control the smart home power supply to perform a turning-on operation at the starting time.

The control information may be set on an interface of the terminal by a user. For example, a dialog box may be popped up to ask whether the user wants to perform setting and to provide options to the user. Or, a window for edition may be provided to the user for editing control information, and the like. The user may set the usage time and usage states of respective home appliances according to his/her own preferences, and one or more embodiments does not impose specific limitations on this. The control information at least includes operation types of smart home power supplies, for example, on or off. For example, the control information may further include one of more of a starting time, a lasting time or an ending time.

For example, this step may include the following steps:

when the control information is turning on the smart home power supply and includes the starting time and the lasting time, sending a control instruction carrying the address of the smart home power supply, the starting time and the lasting time to the smart router to control the smart home power supply to perform a turning-on operation at the starting time and to perform a turning-off operation when a turning-on duration reaches the lasting time.

For example, the user sets the starting time of a rice cooker as 5:00, a.m., or the user sets the starting time of a washing machine as 15:00, and the lasting time as 1.5 hours, and the like.

In step S25, when the control information is turning off the smart home power supply, a control instruction carrying the address of the smart home power supply is sent to the smart router to control the smart home power supply to perform a turning-off operation.

In one or more embodiments, after receiving the control instruction, the smart router may directly send a wireless signal to the smart home power supply to control the smart home power supply to turn on or off, and thereby to achieve a smart control purpose.

In one or more embodiments, alternatively or additionally, the above method may further include:

obtaining information on usage habits set for the home appliances by the user;

when the information on usage habits indicates that a home appliance is not frequently used, detecting on a regular interval whether a turning-on duration of a smart home power supply connected to the home appliance exceeds a preset threshold; and

if the turning-on duration exceeds the threshold, sending a control instruction to the smart router to control the smart home power supply to perform a turning-off operation.

In one or more embodiments, when a smart home power supply encounters with an abnormality, such as power off during operation, the information on the abnormality may be reported to the smart router in real time, and may be notified by the smart router to the terminal so that the user may view and know such abnormality in time.

In the above method provided by one or more embodiments, after successful automatic matching of a smart router with a plurality of smart home power supplies, addresses assigned for the smart home power supplies by the smart router are obtained, and information on a plurality of home appliances connected to the smart home power supplies is obtained. A correspondence between the information on the home appliances and the addresses of the smart home power supplies is established. Control information set for a home appliance by a user is obtained, an address of a smart home power supply connected to the home appliance is searched from the correspondence, and a control instruction is sent to the smart router according to the control information and the address of the smart home power supply to control the smart home power supply to perform a corresponding operation. Thus, a smart control on the smart home power supplies is realized to greatly facilitate user's operations and usage. Consequently, purposes such as energy-saving, safety and convenience to life are achieved and optimized usage and management of home appliances are realized.

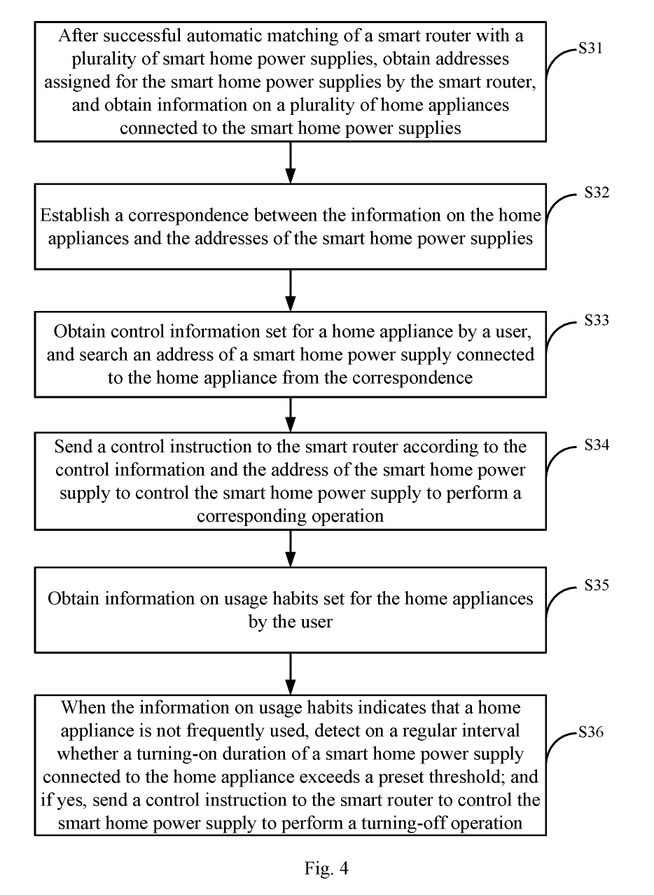

FIG. 4 is a flowchart showing a method for controlling a smart home power supply according to another exemplary embodiment. As shown in FIG. 4, the method may be implemented in a terminal and includes the following steps.

In step S31, after successful automatic matching of a smart router with a plurality of smart home power supplies, addresses assigned for the smart home power supplies by the smart router are obtained, and information on a plurality of home appliances connected to the smart home power supplies is obtained.

In step S32, a correspondence between the information on the home appliances and the addresses of the smart home power supplies is established.

In step S33, control information set for a home appliance by a user is obtained, an address of a smart home power supply connected to the home appliance is searched from the correspondence.

The obtaining of control information set for a home appliance by a user may include:

providing the information on the home appliances to the user, and receiving control information set for a home appliance by the user; or

analyzing the information on the home appliances to generate the control information.

In step S34, a control instruction is sent to the smart router according to the control information and the address of the smart home power supply to control the smart home power supply to perform a corresponding operation.

For example, this step may include:

when the control information is turning on the smart home power supply, sending a control instruction carrying the address of the smart home power supply to the smart router to control the smart home power supply to perform a turning-on operation; or

when the control information is turning off the smart home power supply, sending a control instruction carrying the address of the smart home power supply to the smart router to control the smart home power supply to perform a turning-off operation.

For example, when the control information is turning on the smart home power supply, the sending of a control instruction carrying the address of the smart home power supply to the smart router to control the smart home power supply to perform a turning-on operation, includes:

when the control information is turning on the smart home power supply and includes a starting time, sending a control instruction carrying the address of the smart home power supply and the starting time to the smart router to control the smart home power supply to perform a turning-on operation at the starting time; or

when the control information is turning on the smart home power supply and includes the starting time and a lasting time, sending a control instruction carrying the address of the smart home power supply, the starting time and the lasting time to the smart router to control the smart home power supply to perform a turning-on operation at the starting time and to perform a turning-off operation when a turning-on duration reaches the lasting time.

In step S35, information on usage habits set for the home appliances by the user is obtained.

A user may set usage habits for home appliances on a setting interface provided by the terminal. The set information may include “frequently used”, “not frequently used”, “used every day”, and the like, and one or more embodiments does not impose specific limitations on this.

In step S36, when the information on usage habits indicates that a home appliance is not frequently used, whether a turning-on duration of a smart home power supply connected to the home appliance exceeds a preset threshold is detected on a regular interval. If the turning-on duration exceeds the threshold, a control instruction is sent to the smart router to control the smart home power supply to perform a turning-off operation.

When a home appliance is not used frequently, a user may usually forget to turn off the power supply. Thus, situations such as current leakage or power waste may occur. By regularly detecting and turning off the smart home power supply, it may prevent these situations from happening and thereby to effectively save power. As a result, a purpose for managing smart home power supplies in real time is achieved, energy saving and home security are realized, and thereby user's usage is greatly facilitated and user's experience is improved.

For example, when the smart router determines that the turning-on duration of a home appliance exceeds a preset threshold, the smart router may issue warning information including but not limited to voice warning or light flashing warning, and the like, the warning information may be issued by the smart router or may be notified to the terminal by the smart router, and then warning information may be issued by the terminal to notify the user. The preset threshold may be set according to actual requirements and is not limited to specific value, for example, may be set as 5 hours, 8 hours, 10 hours and the like.

In one or more embodiments, when there are a relatively large number of home appliances in a home, a user may set information on usage habits for each of the home appliances or for a part of the home appliances according to actual requirements, and one or more embodiments does not impose specific limitations on this.

In one or more embodiments, alternatively or additionally, the information on the home appliances includes identification information of the home appliances, or includes both the identification information and property information of the home appliances, wherein the property information is displayed when being viewed by the user.

In the above method provided by one or more embodiments, after successful automatic matching of a smart router with a plurality of smart home power supplies, addresses assigned for the smart home power supplies by the smart router are obtained, and information on a plurality of home appliances connected to the smart home power supplies are obtained. A correspondence between the information on the home appliances and the addresses of the smart home power supplies is established. Control information set for a home appliance by a user is obtained, an address of a smart home power supply connected to the home appliance is searched from the correspondence, and a control instruction is sent to the smart router according to the control information and the address of the smart home power supply to control the smart home power supply to perform a corresponding operation. Thus, a smart control on the smart home power supplies is realized to greatly facilitate user's operations and usage. Consequently, purposes such as energy-saving, safety and convenience to life are achieved and optimized usage and management of home appliances are realized. For example, if some home appliances which are not used frequently are in an operation state and a user cannot turn off these home appliances in time, remote operations may be performed by a terminal to realize a smart management on the smart home power supplies.

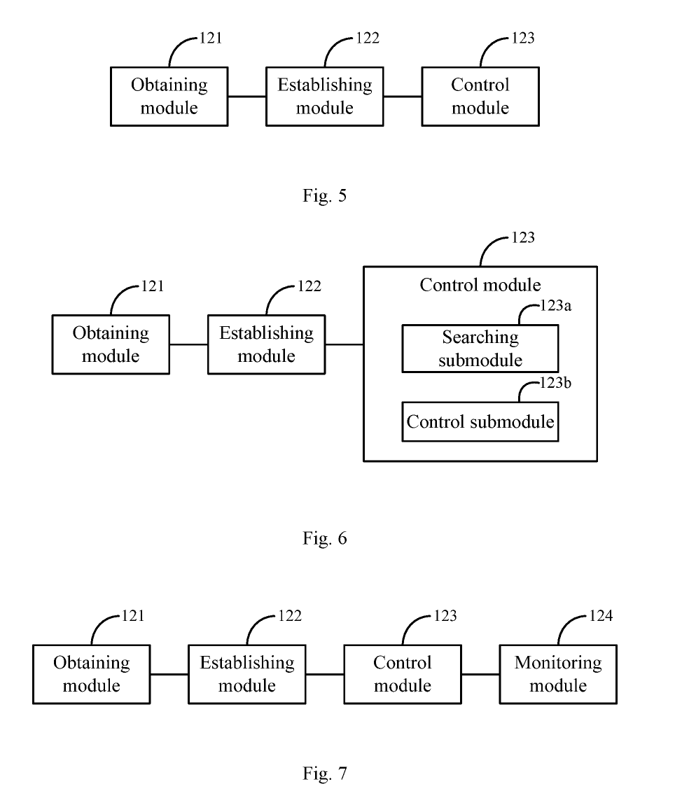

FIG. 5 is a block diagram showing a device for controlling a smart home power supply according to another exemplary embodiment. Referring to FIG. 5, the device includes an obtaining module 121, an establishing module 122 and a control module 123.

The obtaining module 121 is configured to, after successful automatic matching of a smart router with a plurality of smart home power supplies, obtain addresses assigned for the smart home power supplies by the smart router, and obtain information on a plurality of home appliances connected to the smart home power supplies.

The establishing module 122 is configured to establish a correspondence between the information on the home appliances and the addresses of the smart home power supplies.

The control module 123 is configured to obtain control information set for a home appliance by a user, search an address of a smart home power supply connected to the home appliance from the correspondence, and send a control instruction to the smart router according to the control information and the address of the smart home power supply to control the smart home power supply to perform a corresponding operation.

In one or more embodiments, alternatively or additionally, the obtaining module 121 may be a Bluetooth module capable of sending and receiving instructions via a Bluetooth manner to communicate with the smart router. The establishing module 122 and the control module 123 may be implemented by microprocessors which are responsible for data processing to realize the functions of the two modules.

Referring to FIG. 6, alternatively or additionally, the control module 123 may include:

a searching submodule 123a configured to obtain control information set for a home appliance by a user and search an address of a smart home power supply connected to the home appliance from the correspondence; and

a control submodule 123b configured to, when the control information is turning on the smart home power supply, send a control instruction carrying the address of the smart home power supply to the smart router to control the smart home power supply to perform a turning-on operation; or when the control information is turning off the smart home power supply, send a control instruction carrying the address of the smart home power supply to the smart router to control the smart home power supply to perform a turning-off operation.

In one or more embodiments, alternatively or additionally, the control submodule 123b is configured to:

when the control information is turning on the smart home power supply and includes a starting time, send a control instruction carrying the address of the smart home power supply and the starting time to the smart router to control the smart home power supply to perform a turning-on operation at the starting time.

In one or more embodiments, alternatively or additionally, the control submodule 123b is configured to:

when the control information is turning on the smart home power supply and includes the starting time and a lasting time, send a control instruction carrying the address of the smart home power supply, the starting time and the lasting time to the smart router to control the smart home power supply to perform a turning-on operation at the starting time and to perform a turning-off operation when a turning-on duration reaches the lasting time.

Referring to FIG. 7, in one or more embodiments, alternatively or additionally, the obtaining module 121 is further configured to obtain information on usage habits set for the home appliances by the user.

The device further includes:

a monitoring module 124 configured to, when the information on usage habits indicates that a home appliance is not frequently used, detect on a regular interval whether a turning-on duration of a smart home power supply connected to the home appliance exceeds a preset threshold; and if the turning-on duration exceeds the threshold, send a control instruction to the smart router to control the smart home power supply to perform a turning-off operation.

In one or more embodiments, alternatively or additionally, the control module 123 may be configured to:

provide the information on the home appliances to the user, and receive control information set for a home appliance by the user; or

analyze the information on the home appliances to generate the control information.

In one or more embodiments, alternatively or additionally, the information on the home appliances includes identification information of the home appliances, or includes both the identification information and property information of the home appliances, wherein the property information is displayed when being viewed by the user.

The specific manners for respective modules performing functions in the above devices of the embodiments have been described in the embodiments relating to the methods, and a duplicate description is omitted herein.

In the above device provided by one or more embodiments, after successful automatic matching of a smart router with a plurality of smart home power supplies, addresses assigned for the smart home power supplies by the smart router are obtained, and information on a plurality of home appliances connected to the smart home power supplies are obtained. A correspondence between the information on the home appliances and the addresses of the smart home power supplies is established. Control information set for a home appliance by a user is obtained, an address of a smart home power supply connected to the home appliance is searched from the correspondence, and a control instruction is sent to the smart router according to the control information and the address of the smart home power supply to control the smart home power supply to perform a corresponding operation. Thus, a smart control on the smart home power supplies is realized to greatly facilitate user's operations and usage. Consequently, purposes such as energy-saving, safety and convenience to life are achieved and optimized usage and management of home appliances are realized.

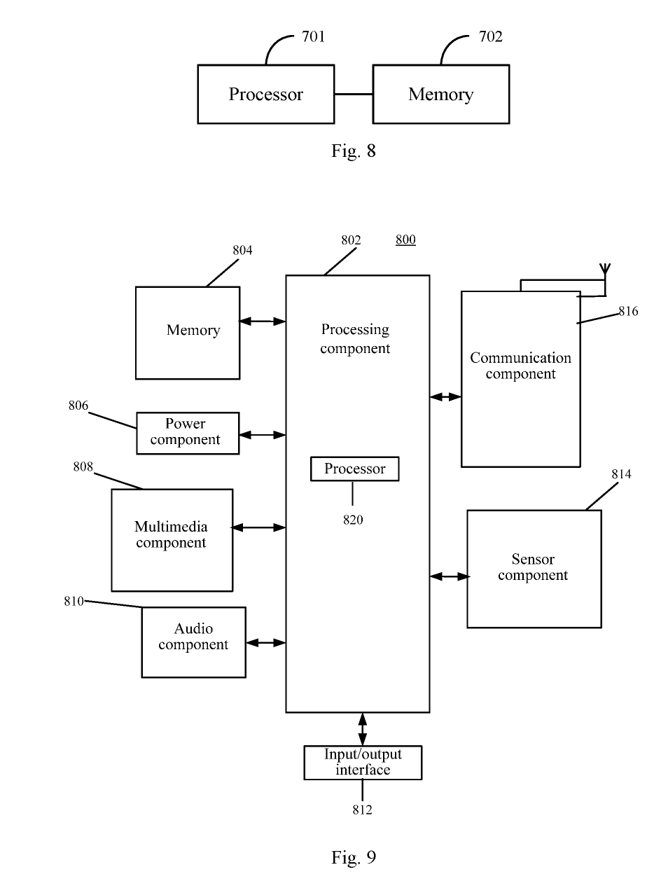

FIG. 8 is a block diagram of a device for controlling a smart home power supply according to another exemplary embodiment. Referring to FIG. 8, the device includes a processor 701 and a memory 702 for storing instructions executable by the processor.

The processor 701 is configured to perform:

after successful automatic matching of a smart router with a plurality of smart home power supplies, obtaining addresses assigned for the smart home power supplies by the smart router, and obtaining information on a plurality of home appliances connected to the smart home power supplies;

establishing a correspondence between the information on the home appliances and the addresses of the smart home power supplies; and

obtaining control information set for a home appliance by a user, searching an address of a smart home power supply connected to the home appliance from the correspondence, and sending a control instruction to the smart router according to the control information and the address of the smart home power supply to control the smart home power supply to perform a corresponding operation.

FIG. 9 is a block diagram showing a device 800 for controlling a smart home power supply according to another exemplary embodiment. For example, the device 800 may be a mobile phone, a computer, a digital broadcast terminal, a messaging device, a gaming console, a tablet, a medical device, exercise equipment, a personal digital assistant, and the like.

Referring to FIG. 9, the device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods provided by any one of the above embodiments. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G or 3G or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods provided by any one of the above embodiments. Each module, such as discussed with respect to FIGS. 5-7, may take the form of a packaged functional hardware unit designed for use with other components, a portion of a program code (e.g., software or firmware) executable by the processor 820 or the processing circuitry that usually performs a particular function of related functions, or a self-contained hardware or software component that interfaces with a larger system, for example.

In exemplary embodiments, there is also provided a non-transitory computer-readable storage medium including instructions, such as included in the memory 804, executable by the processor 820 in the device 800, for performing the above-described methods provided by any one of the above embodiments. For example, the non-transitory computer-readable storage medium may be a ROM, a RAM, a CD-ROM, a magnetic tape, a floppy disc, an optical data storage device, and the like.

There is also provided a non-transitory computer-readable storage medium. When instructions in the storage medium are executed by a processor of a mobile terminal, the mobile terminal may be caused to perform any one of the above methods.

In the non-transitory computer-readable storage medium provided by the presnet embodiment, after successful automatic matching of a smart router with a plurality of smart home power supplies, addresses assigned for the smart home power supplies by the smart router are obtained, and information on a plurality of home appliances connected to the smart home power supplies are obtained. A correspondence between the information on the home appliances and the addresses of the smart home power supplies is established. Control information set for a home appliance by a user is obtained, an address of a smart home power supply connected to the home appliance is searched from the correspondence, and a control instruction is sent to the smart router according to the control information and the address of the smart home power supply to control the smart home power supply to perform a corresponding operation. Thus, a smart control on the smart home power supplies is realized to greatly facilitate user's operations and usage. Consequently, purposes such as energy-saving, safety and convenience to life are achieved and optimized usage and management of home appliances are realized.

The technical solutions provided by embodiments of the present disclosure may have the following advantageous effects:

After successful automatic matching of a smart router with a plurality of smart home power supplies, addresses assigned for the smart home power supplies by the smart router are obtained, and information on a plurality of home appliances connected to the smart home power supplies are obtained. A correspondence between the information on the home appliances and the addresses of the smart home power supplies is established. Control information set for a home appliance by a user is obtained, an address of a smart home power supply connected to the home appliance is searched from the correspondence, and a control instruction is sent to the smart router according to the control information and the address of the smart home power supply to control the smart home power supply to perform a corresponding operation. Thus, a smart control on the smart home power supplies is realized to greatly facilitate user's operations and usage. Consequently, purposes such as energy-saving, safety and convenience to life are achieved and optimized usage and management of home appliances are realized.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and embodiments be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method, comprising:
obtaining, by a terminal, an assigned address for a smart home power supply connected to a smart router, and obtaining information on one or more home appliances connected to the smart home power supply;
establishing, by the terminal, a correspondence between the information on the one or more home appliances and the assigned address of the smart home power supply; and
obtaining, by the terminal, control information for a home appliance, searching an address of a smart home power supply connected to the home appliance from the correspondence, and sending a control instruction to the smart router according to the control information and the address of the smart home power supply to control the smart home power supply to perform a corresponding operation.

2. The method according to claim 1, wherein, the sending of a control instruction to the smart router according to the control information and the address of the smart home power supply to control the smart home power supply to perform a corresponding operation, comprises:
when the control information is turning on the smart home power supply, sending a control instruction carrying the address of the smart home power supply to the smart router to control the smart home power supply to perform a turning-on operation; or
when the control information is turning off the smart home power supply, sending a control instruction carrying the address of the smart home power supply to the smart router to control the smart home power supply to perform a turning-off operation.

3. The method according to claim 2, wherein, when the control information is turning on the smart home power supply, the sending of a control instruction carrying the address of the smart home power supply to the smart router to control the smart home power supply to perform a turning-on operation, comprises:
when the control information is turning on the smart home power supply and comprises a starting time, sending a control instruction carrying the address of the smart home power supply and the starting time to the smart router to control the smart home power supply to perform a turning-on operation at the starting time.

4. The method according to claim 3, wherein, when the control information is turning on the smart home power supply and comprises a starting time, the sending of a control instruction carrying the address of the smart home power supply and the starting time to the smart router to control the smart home power supply to perform a turning-on operation at the starting time, comprises:
when the control information is turning on the smart home power supply and comprises the starting time and a lasting time, sending a control instruction carrying the address of the smart home power supply, the starting time and the lasting time to the smart router to control the smart home power supply to perform a turning-on operation at the starting time and to perform a turning-off operation when a turning-on duration reaches the lasting time.

5. The method according to claim 1, further comprising:
obtaining information on usage habits for the home appliances set by a user;
when the information on usage habits indicates that a home appliance is not frequently used, detecting on a regular interval whether a turning-on duration of a smart home power supply connected to the home appliance exceeds a preset threshold; and
when the turning-on duration exceeds the threshold, sending a control instruction to the smart router to control the smart home power supply to perform a turning-off operation.

6. The method according to claim 1, wherein obtaining the control information for the home appliance comprises:
providing the information on the home appliances to a user, and receiving the control information for a home appliance set by the user; or
analyzing the information on the home appliances to generate the control information.

7. The method according to claim 1, wherein the information on the home appliances comprises identification information of the home appliances, or comprises both the identification information and property information of the home appliances, wherein the property information is displayed when being viewed by a user.

8. A device, comprising:
a processor; and
a memory for storing instructions executable by the processor;
wherein the processor is configured to perform:
obtaining an assigned address for a smart home power supply connected to a smart router, and obtaining information on one or more home appliances connected to the smart home power supply;
saving a correspondence between the information on the one or more home appliances and the assigned address of the smart home power supply in a correspondence storage; and
obtaining control information for a home appliance, searching an address of a smart home power supply connected to the home appliance from the correspondence storage, and sending a control instruction to the smart router according to the control information and the address of the smart home power supply to control the smart home power supply to perform a corresponding operation.

9. The device according to claim 8, wherein the processor is configured to perform:
when the control information is turning on the smart home power supply, sending a control instruction carrying the address of the smart home power supply to the smart router to control the smart home power supply to perform a turning-on operation; or
when the control information is turning off the smart home power supply, sending a control instruction carrying the address of the smart home power supply to the smart router to control the smart home power supply to perform a turning-off operation.

10. The device according to claim 9, wherein the processor is configured to perform:
when the control information is turning on the smart home power supply and comprises a starting time, sending a control instruction carrying the address of the smart home power supply and the starting time to the smart router to control the smart home power supply to perform a turning-on operation at the starting time.

11. The device according to claim 10, wherein the processor is configured to perform:
when the control information is turning on the smart home power supply and comprises the starting time and a lasting time, sending a control instruction carrying the address of the smart home power supply, the starting time and the lasting time to the smart router to control the smart home power supply to perform a turning-on operation at the starting time and to perform a turning-off operation when a turning-on duration reaches the lasting time.

12. The device according to claim 8, wherein the processor is further configured to perform:
obtaining information on usage habits for the home appliances set by a user;
when the information on usage habits indicates that a home appliance is not frequently used, detecting on a regular interval whether a turning-on duration of a smart home power supply connected to the home appliance exceeds a preset threshold; and
when the turning-on duration exceeds the threshold, sending a control instruction to the smart router to control the smart home power supply to perform a turning-off operation.

13. The device according to claim 8, wherein the processor is configured to perform:
providing the information on the home appliances to a user, and receiving the control information for a home appliance set by the user; or
analyzing the information on the home appliances to generate the control information.

14. The device according to claim 8, wherein the information on the home appliances comprises identification information of the home appliances, or comprises both the identification information and property information of the home appliances, wherein the property information is displayed when being viewed by a user.

15. A non-transitory computer readable storage medium comprising instructions, executable by a processor in a device for performing acts comprising:
obtaining an assigned address for a smart home power supply connected to a smart router, and obtaining information on one or more home appliances connected to the smart home power supply;
saving a correspondence relationship between the information on the one or more home appliances and the assigned address of the smart home power supply in a correspondence storage; and
obtaining control information for a home appliance, obtaining an address of a smart home power supply connected to the home appliance from the correspondence storage, and sending a control instruction to the smart router according to the control information and the address of the smart home power supply to control the smart home power supply to perform a corresponding operation.

16. The non-transitory computer readable storage medium according to claim 15, wherein the acts further comprise:
when the control information is turning on the smart home power supply, sending a control instruction carrying the address of the smart home power supply to the smart router to control the smart home power supply to perform a turning-on operation; or
when the control information is turning off the smart home power supply, sending a control instruction carrying the address of the smart home power supply to the smart router to control the smart home power supply to perform a turning-off operation.

17. The non-transitory computer readable storage medium according to claim 16, wherein the acts further comprise:
when the control information is turning on the smart home power supply and comprises a starting time, sending a control instruction carrying the address of the smart home power supply and the starting time to the smart router to control the smart home power supply to perform a turning-on operation at the starting time.

18. The non-transitory computer readable storage medium according to claim 17, wherein the acts further comprise:
when the control information is turning on the smart home power supply and comprises the starting time and a lasting time, sending a control instruction carrying the address of the smart home power supply, the starting time and the lasting time to the smart router to control the smart home power supply to perform a turning-on operation at the starting time and to perform a turning-off operation when a turning-on duration reaches the lasting time.

19. The non-transitory computer readable storage medium according to claim 15, wherein the acts further comprise:
obtaining information on usage habits for the one or more home appliances set by a user;
when the information on usage habits indicates that a home appliance is not frequently used, detecting on a regular interval whether a turning-on duration of a smart home power supply connected to the home appliance exceeds a preset threshold; and
when the turning-on duration exceeds the threshold, sending a control instruction to the smart router to control the smart home power supply to perform a turning-off operation.

20. The non-transitory computer readable storage medium according to claim 15, wherein the acts further comprise:
providing the information on the one or more home appliances to a user, and receiving the control information for a home appliance set by the user; or
analyzing the information on the one or more home appliances to generate the control information.
